(19) United States
(12) Patent Application Publication
(10) Pub. No.: US 2020/0022008 A1
(43) Pub. Date: Jan. 16, 2020

(54) ADDING SCEF TO MF IN NHN ACCESS MODE

(71) Applicant: NOKIA TECHNOLOGIES OY, Espoo (FI)

(72) Inventors: Stephen MAGEE, Scottsdale, AZ (US); Jari Pekka MUSTAJARVI, Espoo (FI); Gyorgy Tamas WOLFNER, Budapest (HU)

(21) Appl. No.: 16/483,863

(22) PCT Filed: Feb. 1, 2018
(86) PCT No.: PCT/EP2018/052517

§ 371 Date: Aug. 6, 2019

Related U.S. Application Data
(60) Provisional application No. 62/455,081, filed on Feb. 6, 2017.

(51) Int. Cl. H04W 24/08; H04W 4/70; H04W 8/20

(52) U.S. Cl. CPC H04W 24/08; H04W 92/02; H04W 8/20; H04W 4/70

(57) ABSTRACT

A method of an apparatus in a network outside of a neutral host network, comprising receiving a monitoring request usage the monitoring request message including information defined to start a process to configure the neutral host network to monitor a selected Internet of Things user equipment for specific events, and sending a message, in response to the monitoring request message, toward the neutral host network, wherein said message comprises event monitoring configuration information corresponding to the monitoring request message, and at least part of the event monitoring configuration information causes a neutral host MME in the other network to monitor the selected user equipment for specific events.

### TECHNICAL FIELD

This invention relates generally to unlicensed (e.g. MulteFire) and other non-licensed radio technologies (e.g., U.S. 3.5 GHz band) that do not have direct communication with an HSS server for subscriber data retrieval and authentication, where instead they access an AAA server, and, more specifically, relates to adding SCEF to MulteFire (MF) in NHN access mode.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Abbreviations that may be found in the specification and/or the drawing figures are defined below, after the main part of the detailed description section.

This disclosure relates to a new technology initiative called MulteFire (MF). MF is, e.g., a Qualcomm-Nokia co-operation initiative to create a new communications system where LTE radio technology is applied to an unlicensed radio band. The difference from the currently on-going Licensed Assisted Access (LAA/LTE-U) activities is that in MF there is not expected to be a macro network or licensed carriers in use, but instead the MF is a standalone system designed to operate on unlicensed band frequencies. The MF can operate, e.g., on the same 5 GHz band as Wi-Fi does but is not limited to this. MF specifications are developed in the MulteFire Alliance. Wi-Fi is a technology for wireless local area networking with devices based on the IEEE 802.11 standards. Wi-Fi is a trademark of the Wi-Fi Alliance.

In the MF architecture, the radio interface terminates in the UE and in the MF Access Point (MF-AP) on the network side. The MF-AP can be connected to a Neutral Host Network (NHN), which realizes the minimum set of necessary core network functions for the MF operations to provide IP connectivity. When MF-AP is deployed with an NHN, the network setup may resemble Wi-Fi deployment, however operating with 3GPP protocols. Therefore NHN is −considered a non-3GPP access network when interworking with a 3GPP PLMN is deployed.

The next release of MF specifications will be Rel-1.1. The most important enhancement over Rel-1.0 is the support of CIoT (Cellular Internet of Things) features developed in 3GPP.

### BRIEF DESCRIPTION OF THE DRAWINGS

In the attached Drawing Figures:

FIG. 1A is a block diagram of 3GPP Architecture for Machine-Type Communication (Roaming), and is copied from FIG. 4.2-1b of 3GPP TS 23.682 V14.2.0 (2016- -v12);

FIG. 1B is a block diagram of 3GPP interworking with MF NHN Architecture, copied from MF.202;

FIG. 2 is a block diagram for a Qualcomm proposal on adding SCEF into MF NHN architecture;

FIG. 3 is a block diagram of an exemplary architecture proposal for adding CIOT/MTC features to MF NHN, in an exemplary embodiment;

FIG. 4 is a signaling diagram of monitoring event configuration and deletion via an HSS procedure in 3GPP, and is a reproduction of FIG. 5.6.1.1-1 from 3GPP TS 23.682;

FIG. 5 is a signaling diagram for monitoring event configuration via an HSS procedure in MulteFire, in accordance with an exemplary embodiment;

FIG. 6 is a signaling diagram for monitoring event configuration via a non-3GPP PSP procedure in MulteFire, in accordance with an exemplary embodiment;

FIG. 7 is a signaling diagram for connection establishment using IWK-SCEF for non-IP data delivery, in accordance with an exemplary embodiment;

FIG. 8 is a block diagram of an exemplary computer system suitable for use as any of the network elements described herein; and

FIGS. 9 to 12 are logic flow diagrams for adding SCEF to MF in NHN access mode, and illustrate the operation of an exemplary method or methods, a result of execution of computer program instructions embodied on a computer readable memory, functions performed by logic implemented in hardware, and/or interconnected means for performing functions in accordance with exemplary embodiments.

FIG. 13 is a block diagram of an alternative solution/scenario where the SCEF resides in the NHN core network.

### DETAILED DESCRIPTION OF THE DRAWINGS

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

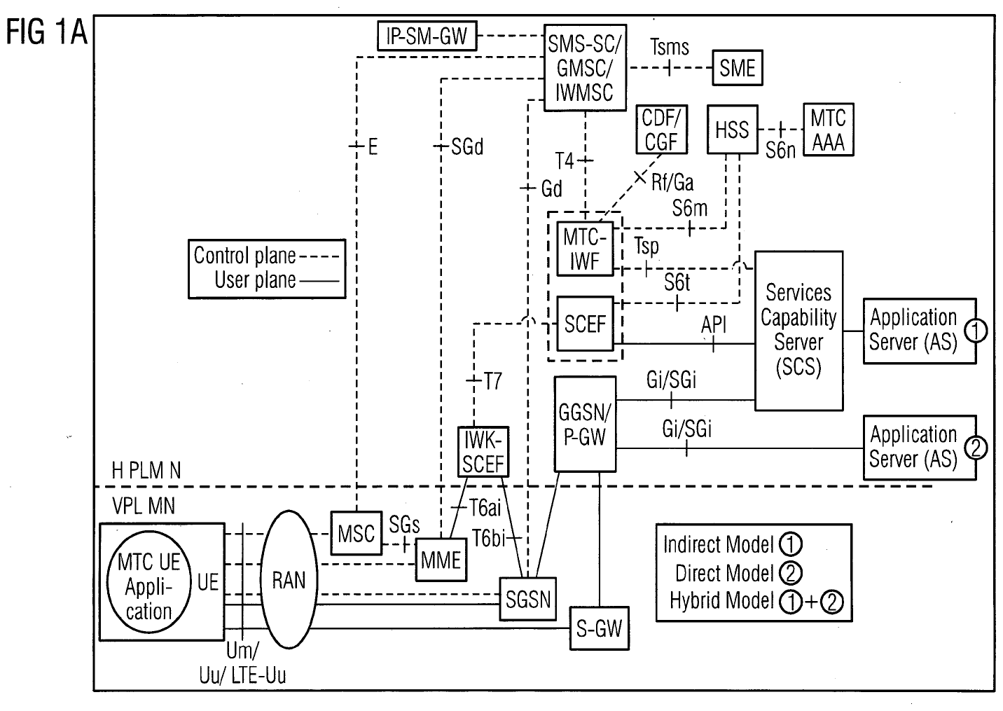

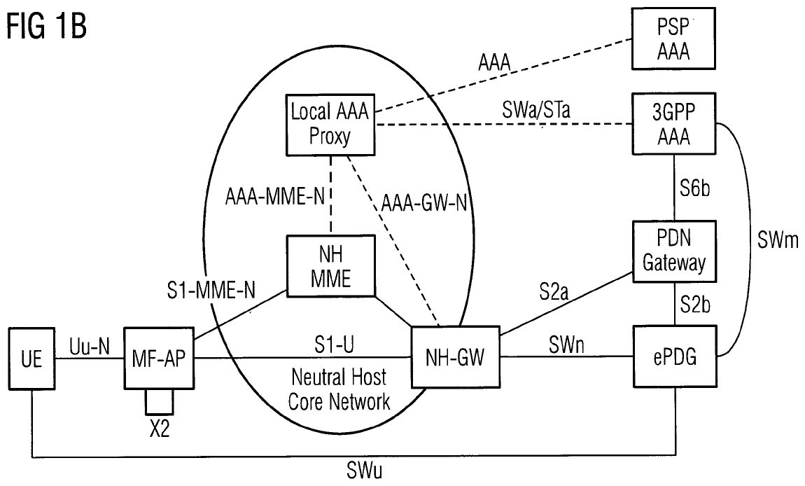

An important aspect of the enhancement related to the support of CIoT features is how a Neutral Host Network (NHN) can be connected to Service Capability Exposure Function (SCEF) specified in 3GPP TS 23.682. According to 3GPP specifications, the SCEF is in the HPLMN and the Interworking-SCEF is in the VPLMN. FIG. 1A (FIG. 4-2-1b copied from 3GPP TS 23.682) presents the 3GPP architecture.

In the MF architecture, there is no VPLMN, but the NHN is connected to the 3GPP PLMN via SWa when the 3GPP PLMN considers NHN as an untrusted Non-3GPP access network and via STa and via S2a when the 3GPP PLMN considers NHN as a Trusted Non-3GPP access network. Similarly, there is an AAA interface (Diameter/RADIUS) with the PSP when non-3GPP operator is providing the service but this does not have 3GPP specific STa/SWa components by default. FIG. 1B presents the architecture (copied from MF.202).

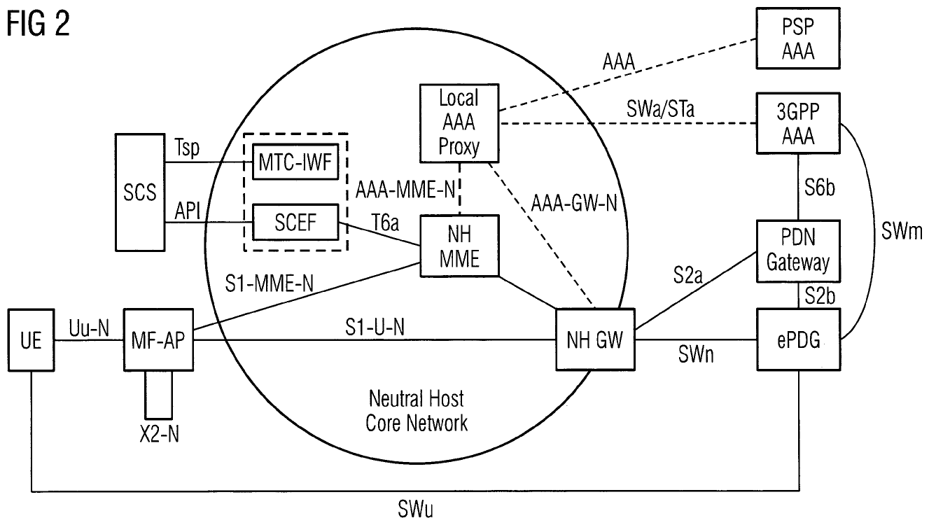

According to a Qualcomm proposal, the SCEF can be added into the NHN (see FIG. 2, which is copied from Qualcomm MF contribution mf2017.037.00). A problem of this proposal is that it is not clear how the SCEF can get subscription-related information and thus this technique most probably can work only with features not requiring subscription information and HSS interaction. Note that in the 3GPP architecture, there is the S6m/S16t interface between the HSS and SCEF/MTC-IWF. Another issue with this technique is that it cannot re-use the SCS deployed in a 3GPP PLMN, as TsP and API interfaces between the SCEF/MTC-IWF are intra-PLMN interfaces. An additional problem with the Qualcomm proposal is that SCS/AS wishing to trigger a monitoring service would not know which SCEF to contact. The UE may use any number of different NHN networks. If a UE authenticates to the service provider (PSP/3GPP), the service provider may be able to deduce the originating NHN entity from the used AAA attributes, but the service provider would still not know which SCEF entity is serving the UE in the NHN network and how to reach the UE. The SCEF and service provider domains (3GPP PLMN/PSP) belong together (˜intra-PLMN interfaces below), but the NHN is the access network provider, and as such, these are separated now.

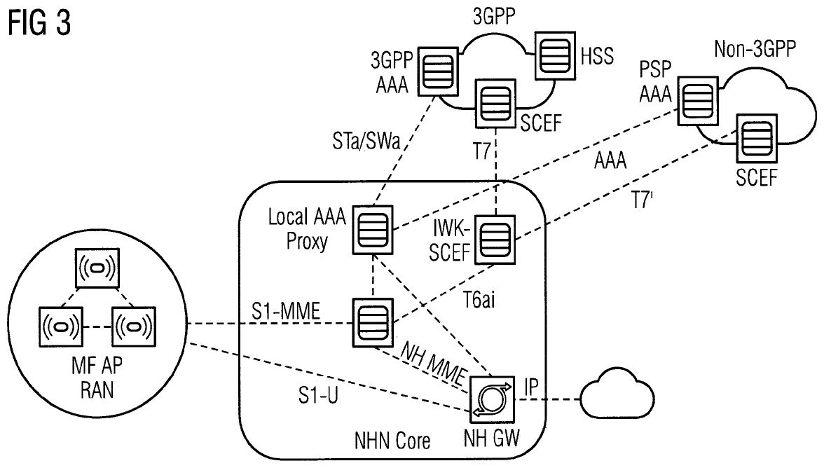

An exemplary embodiment herein proposes to add an IWK-SCEF function to the NHN architecture. See FIG. 3, which is a block diagram of an exemplary architecture proposal for adding CIOT/MTC features to an MF NHN. The IWK-SCEF is connected to the external SCEF that can be in a 3GPP PLMN or in the network of an external Participating Service Provider (PSP) via a slightly modified version of the 3GPP defined T7 interface (illustrated in FIG. 3 as the interface T7′ between the IWK-SCEF and the non-3GPP SCEF).

In this scenario, the IWK-SCEF resides in NHN core network with the following impacts on the NHN core network:

Implementing the IWK-SCEF;

Implementing the T6ai interface between the NH MME and IWK-SCEF (the protocol between IWK-SCEF and NH-MME might be left for implementation, but the functionality should be there); and

Implementing the T7 interface between the IWK-SCEF and SCEF.

With the IWK-SCEF scenario, the IoT applications reside outside the NHN and are located in the PSP network. The trust domain is now the T7 interface. Providing security on this interface is similar to other interfaces (e.g., STa) and is simpler than the trust domain requirements needed between the SCEF and SCS/AS. The 3GPP AAA resides in the MNO network and is used for managing access with non-3GPP networks (e.g., Wi-Fi). The PSP AAA resides in a non-MNO PSP (e.g., non-3GPP) network and is used for managing access with other networks. The non-3GPP network could be Wi-Fi, such as Boingo (Boingo Wireless is an American company that provides mobile Internet access for wireless-enabled consumer devices). A local proxy AAA provides interworking functions for AAA procedures with external AAA servers. It also provides single point of contact in the NHN to these AAA servers and can therefore hide internal structure of the NHN network from them. The proxy maintains trust relationships of the NHN and 3GPP/PSP operators for AAA procedures. It is noted that a 3GPP network covers cellular (e.g., mobile broadband) technologies defined in 3GPP standards, and non-3GPP networks are those networks not covered by such standards.

This scenario has dependencies on the HSS for identity management and subscription management for the monitoring event configuration and device triggering functions, but since the SCEF is now in the PSP network, this dependency is managed by the SCEF and HSS in their home networks and these are not impacted by the deployment of the IWK-SCEF in the MF NHN. There still are possible HSS issues, but these issues are resolved by enhancing the STa/SWa interfaces and adding the required information as new AVPs in the following manner

Event Monitoring configuration requires AVP enhancements to STa/SWa to push the configuration information to the NH MME. This allows the HSS to trigger a subscription update over SWx. Already specified procedures over STa/SWa would deliver the information to the NH MME.

Enhancing the STa/SWa interfaces with AVP enhancements provides the APN and SCEF routing information needed to establish an NIDD connection. The connection is then established using the attach procedures for non-3GPP networks.

Device triggering may work as specified in TS 23.682. As long as the IoT device establishes a NIDD connection prior to a device trigger request, the device is registered in the HSS and the feature works as specified.

The problem of having subscription information in the SCEF is solved by this architecture, as the legacy S6t/S6m interfaces in a PLMN can be used. When a non-3GPP operator (PSP) deploys the SCEF, then the operator can use a proprietary intra-operator interface between PSP SCEF and PSP AAA. Note that there are no specifications for the non-3GPP operator deployed SCEF. Further, this architecture in an exemplary embodiment also solves the problem described above, where an SCS/AS wishing to trigger a monitoring service would not know which SCEF to contact. In exemplary embodiment, in this case the SCS/AS can find the SCEF in the same way as the SCS/AS can find an SCEF in the case when a 3GPP access network is used.

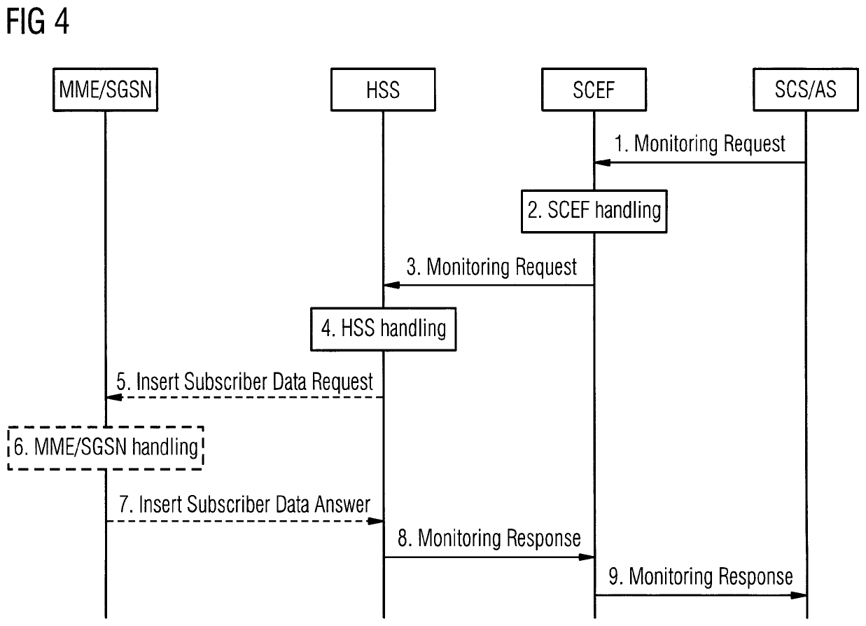

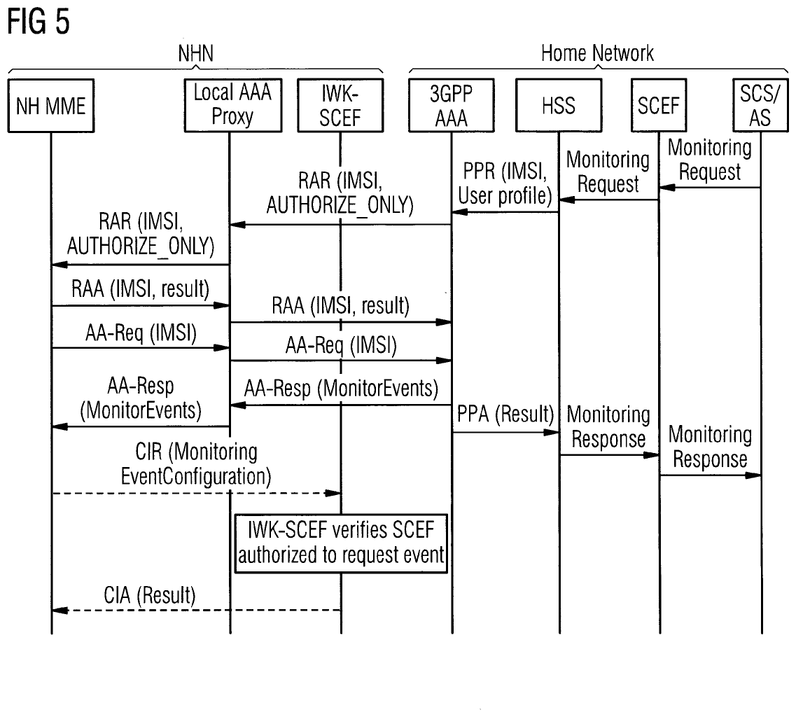

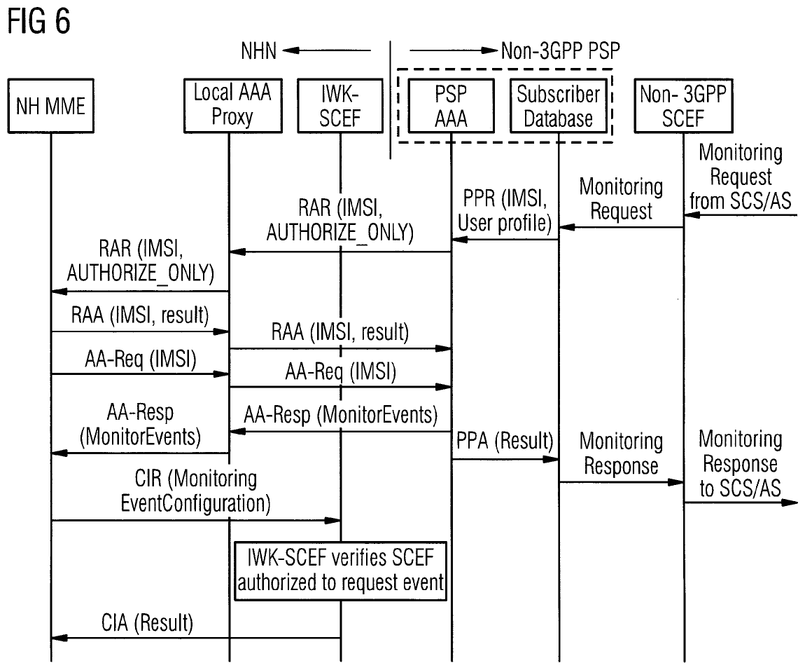

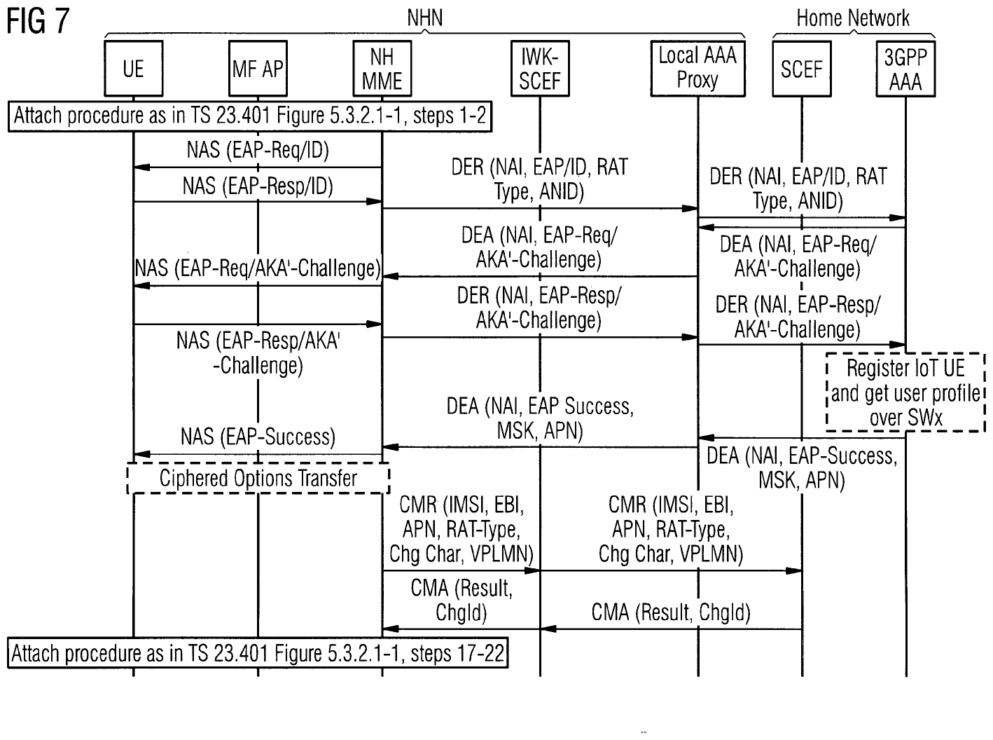

In some procedures, the HSS sends CIOT/MTC related information to the MME; e.g., via Monitoring Event configuration. See FIG. 4, which illustrates a signaling diagram of monitoring event configuration via an HSS procedure in 3GPP, and is a reproduction of FIG. 5.6.1.1-1 from 3GPP TS 23.682. This procedure is not supported in an MF NHN, since there is no HSS interface so steps 5 and 7 are not possible.

In MF NHN, the STa/SWa interfaces resolve this problem with the HSS and are used to enable the IWK-SCEF solution are shown in FIG. 5 for Event Monitoring Configuration and in FIG. 7 for NIDD Connection Establishment.

More particularly, another aspect of the exemplary embodiments is that these types of procedures are supported with the architecture proposed in FIG. 3 via the 3GPP AAA server (PSP AAA server when SCEF is in the PSP's network) and the Local AAA proxy. The procedure is depicted in FIG. 5. In FIG. 5, the Monitoring Request to the SCEF is the Monitoring Request from the SCS/AS to the SCEF illustrated by signaling operation 1 of FIG. 4. Similarly, the Monitoring Response from the SCEF is the Monitoring Response from the SCEF to the SCS/AS illustrated by signaling operation 9 of FIG. 4.

It should be noted that an AAA server is typically an independent network element. This is true because AAAs tend to scale differently than the other network elements, which also leads to them being independent elements. This is starting to change now that AAAs and other network elements are being virtualized. So the trend is to deploy servers and host the AAA software along with the other network elements as virtual network functions. Similarly, in an exemplary embodiment, the Local AAA proxy is a logical function and not a specific network element. For instance, an NH-MME could take care of all local AAA proxy functionalities in a small network. Other options, for other networks, are possible, such as having the local AAA proxy functionality being implemented by one or more network elements. Thus, for any AAA server or AAA proxy herein, it is assumed each of these is a separate network entity, but it is possible that the corresponding functionality is performed by a network element (or network elements) having functions other than AAA functions.

One way to view the signaling operations of FIG. 5 as compared to FIG. 4 is the PPR/PPA, RAR/RAA and AA-Req/AA-Resp operations in FIG. 5 are replacing operations 5 and 7 in FIG. 4. This is done because the MF NHN does not have an interface to the HSS, so this is replaced with the AAA interface which is supported. Additional AVPs may then be used to include the information needed to operate these SCEF features.

Regarding FIG. 5, the following are notes for the information flow.

1) PPR/PPA messages sent over SWx are used to update a profile (3GPP TS 29.273 clause 8.1.2.3).

2) The PPR message contains a User Profile. The User Profile specified in 3GPP TS 29.273 is mapped to the Non-3GPP-User-Data AVP, which does not currently contain any monitoring event information. Monitoring Event information may be added to the PPR message (e.g., a new AVP could be added for Monitoring Event information).

3) The 3GPP AAA initiates RAR to NHN Local AAA proxy which forwards RAR to the NH MME serving the UE. The NH MME responds with RAA. The RAR acts as a trigger to NHN to start AA-Req for a profile update. The NH MME issues AA-Req (AA-Request) to the Local AAA which forwards it to 3GPP AAA. The 3GPP AAA sends an AA-Resp (AA Response) to the Local AAA which forwards the AA-Resp to the NH MME. The AA-Resp currently does not contain any monitoring event information. However, this embodiment adds monitoring event information to the AA-Resp message (e.g., a new AVP is added for Monitoring Event information). Such event monitoring configuration information can be configured for one or more of the following: user equipment reachability (e.g., can the device be contacted by the NHN?); changes in the user equipment location; loss of connectivity with the user equipment; and communication failure with the user equipment.

4) A Configuration Information Request (CIR) is an optional message and sent if the IWK-SCEF needs to update cached information related to continuous event reporting; IWK-SCEF also verifies that the SCEF is known to the IWK-SCEF.

In the event monitoring configuration information flow (FIG. 5), the following observations are noted:

The existing messages specified in TS 23.682 for Monitoring Request and Monitoring Response are used.

The existing procedures for re-authorization over STa specified in TS 29.273 are used for transferring the event monitoring configuration to the NHN.

The AVPs specified in 3GPP TS 29.273 for re-authorization do not contain any monitoring event information. An enhancement is needed to add the event monitoring information to the PPR and AA-Resp messages.

Using the re-authorization procedure gets the event monitoring information to the NH MME which then updates the IWK-SCEF as specified in 3GPP TS 23.682.

A new trigger in the HSS is needed to send updated monitoring event information to NHN via SWx instead of S6a.

While this information flow shows the operation over STa, similar enhancements can be made to enable this procedure over SWa if desired.

The following is a summary of exemplary (but non-limiting) changes from 3GPP specifications to make this work: (1) a new trigger in the HSS is used to send updated monitoring event information to NHN via SWx instead of S6a; (2) Monitoring Event information is added to PPR and AA-Resp messages.

This technique uses the already-specified User Profile Update procedure. The only addition needed is the addition of the information elements related to monitoring.

If a non-3GPP PSP deploys SCEF, then the PSP AAA performs the 3GPP AAA/HSS role in FIG. 5. It is likely RADIUS is used instead of Diameter as in 3GPP, and in this case the monitoring information should be conveyed using the RADIUS CoA procedure. Both RADIUS and Diameter are authentication, authorization, and accounting protocols for computer networks. The general description of the procedure is found in RFC 5176 (Chiba, et al., “Dynamic Authorization Extensions to Remote Authentication Dial In User Service (RADIUS)”, Network Working Group, Request for Comments: 5176 (2008)). SCEF specific information elements should be included into the procedure. NAI may be used instead of IMSI or MSISDN.

The example of FIG. 5 may also be applied to non-3GPP networks. FIG. 6 is a signaling diagram for monitoring event configuration via a non-3GPP PSP procedure in MulteFire, in accordance with an exemplary embodiment. In this example, both functions of the PSP AAA and the Subscriber Database have a dotted line box around both. This implies these functions could be implemented either together in one network element or in separate network elements. One point is the updated event monitoring configuration data is available to the PSP AAA based on a trigger from the PSP specific SCEF. Also, while the PPR/PPA messages are shown, any message could be used, since this actual means of transferring the information is specific to the PSP operator.

The following are notes for this information flow.

1) The subscription DB in the non-3GPP network provides SCEF functions similar to HSS SCEF functions in 3GPP network. It could be implemented as part of a PSP AAA or separately (e.g., this is an implementation decision on the part of the PSP operator).

2) The PPR/PPA messages are shown for illustrative use only. Actual messages are implementation specific. An important point is that updated event monitoring configuration data is available to the PSP AAA based on a trigger from the non-3GPP SCEF.

3) The PSP AAA initiates RAR to the NHN Local AAA proxy, which forwards RAR to NH MME. The NH MME responds with RAA and Local AAA proxy forwards it to PSP AAA.

4) The NH MME issues an AA-Req to the Local AAA, which forwards it to PSP AAA. The PSP AAA sends an AA-Resp to the Local AAA, which forwards the AA-Resp to the NH MME. The AA-Resp does not contain any monitoring event information. This information will be added to the AA-Resp message (e.g., add a new AVP for Monitoring Event information).

5) The Configuration Information Request (CIR) is an optional message and sent if the IWK-SCEF needs to update cached information related to continuous event reporting. The IWK-SCEF also verifies SCEF is known to IWK-SCEF.

An exemplary summary of changes from 3GPP specifications to make this work include the following: add a new trigger in the PSP network to send updated monitoring event information to the NHN; and add Monitoring Event information to AA-Resp messages.

Turning to FIG. 7, this figure is a signaling diagram for connection establishment using IWK-SCEF for non-IP data delivery, in accordance with an exemplary embodiment. The following are notes for the information flow in FIG. 7.

1) The attach procedure specified for MulteFire is used as it is specified in clause 6.2.2 of MFA MF.202. The use case is an IoT UE which needs access to Application Servers in the MNO domain As part of the attach procedure, EAP-AKA′ is used for authentication.

2) As part of this procedure, the existing procedure which the 3GPP AAA uses to register the UE with the HSS is maintained. This allows the service provider to deduce the originating NHN entity from the used AAA attributes. The HSS sends the User Profile containing APN related information to the 3GPP AAA after the authentication succeeds. The 3GPP AAA sends the APN information to the Local AAA which sends the APN information to the NH MME.

3) The latest version of 3GPP TS 29.273 identifies the Non-IP Data Delivery information (SCEF ID, SCEF Realm) as information which need not be in the APN-Configuration AVP. Consequently, there is no guarantee the SCEF information needed to establish the NIDD connection is provided to the NH MME. The DEA message may be updated to add this information (e.g., via a new AVP). By updating the DEA message with this information, the MF NHN can deduce which SCEF to contact for Non-IP Data Delivery.

4) The CMR/CMA as specified in 3GPP TS 23.682 are used without modification to establish the NIDD connection. The NH MME uses the SCEF-ID and the SCEF realm that the NH MME received in the subscribed APN as the Destination-Host AVP and the Destination-Realm AVP in the CMR message sent over the T6ai interface. The technique described immediately above allows the MF NHN can deduce which SCEF to contact for Non-IP Data Delivery

5) The IWK-SCEF behaves as a Diameter Proxy and forwards Diameter messages, keeping the Destination-Host and Destination-Realm AVPs unchanged.

Information used for SCEF discovery and routing (SCEF ID, SCEF Realm) may not be included in the APN Configuration AVP. An AVP update may be needed to add this information.

Summary of changes from 3GPP specifications to make this work include following: update the DEA message to add the NIDD related connection information (e.g., via a new AVP).

While enhancements are required for STa and SWa for this solution, these are minor impacts and do not change the MF NHN and MNO architectures. These impacts only affect the PSPs who want to provide IoT services and are also minor changes for the PSPs. Additionally, there are no new procedures introduced by this solution.

Non-IP Data Delivery using a Point-to-Point (PtP) SGi tunnel is also an option in 3GPP specifications. This delivery option can be supported with this architecture using Trusted mode when the PGW is in the MNO's network. It requires the extension of S2a with S5/S8 extensions specified for this purpose in 3GPP, but no other architecture changes are needed.

Another advantage of this solution is easy support for different Non-IP data delivery options. If the NHN is configured to use SGi based delivery via S2a for NIDD traffic, APN configuration is still needed to correctly establish the tunneling to the Application Servers in the MNO PSP. In this case, the APN configuration information contains the APN information needed to establish the connection.

For the case when the PSP is non-MNO, the PSP AAA server (or the subscriber database behind the AAA server) should provide the required HSS functions and data. There is also a need to enhance the AAA interface with new information elements between NHN and PSP-AAA for providing event monitoring, SCEF discovery and routing information and APN configuration information for Non-IP data delivery. These extensions can also be standardized in MFA.

The IWK-SCEF also manages the scaling of SCEFs nicely which is expected given the likely composition of MF IoT devices and the desire to provide a neutral hosting environment for IoT devices from multiple PSPs. Also, this scenario allows local IoT applications and services.

Regarding the ability for the SCS/AS to find the SCEF in the same way as the SCS/AS can find an SCEF in the case when a 3GPP access network is used, the structure in FIG. 3 and the flows in FIGS. 5 and 6 allow this to happen. For instance, in FIG. 5, the 3GPP AAA, HSS and SCEF are in the home network and the IWK-SCEF, Local AAA and NH MME are in the NHN. In FIG. 7, there is a similar allocation. It is this allocation of HSS and SCEF in the home network that helps to provide the ability for the SCS/AS to find the SCEF in the same way as the SCS/AS can find an SCEF in the case when a 3GPP access network is used.

It is also noted that there could be problems if NHN would provide SCEF. The following are two possible options for solving these problems:

Option 1 would be to let NH-MME select the SCEF for the UE and indicate the selected SCEF to the PSP in AAA attributes during authentication or authorization. This would entail adding a completely new attribute (AVP) to AAA messages carrying EAP (Diameter DER/RADIUS Access Request). Alternatively, it is the Local AAA proxy which could select the SCEF for the UE.

Option 2 would allow instead the PSP to query the SCEF location from the NHN using Diameter RAR/RAA or RADIUS CoA exchange with suitable indicators.

Thus, an exemplary embodiment herein proposes also a solution where SCEF could reside in NHN and introduces new signaling to indicate SCEF location to the service provider (PSP or 3GPP MNO). The proposed solution requires the NHN to select SCEF for the UE itself and this selection is made known to the PSP/3GPP MNO. Selection could happen in the Local AAA proxy as this has an overall view over the NHN network. The first solution pushes the SCEF information to the PSP/3GPP AAA piggybacked into AAA authentication and authorization signaling (DIAMETER DER / RADIUS-Access-Request). This could be provided in the final message of the AAA authentication and authorization exchange to the PSP/3GPP AAA server. The second solution uses a pull model where the PSP/3GPP AAA would request the SCEF information from the NHN (instead of the HSS). The UE still has AAA context active with the PSP/3GPP AAA for the NHN which previously authenticated the user and this can be used to access the NHN. The solution could deploy suitably built DIAMETER RAR/RAA messages. In one implementation, the PSP/3GPP AAA would send RAR to indicate the requested information and the NHN Local AAA proxy would provide the RAA with the requested information. Alternatively, a RADIUS CoA procedure could be used.

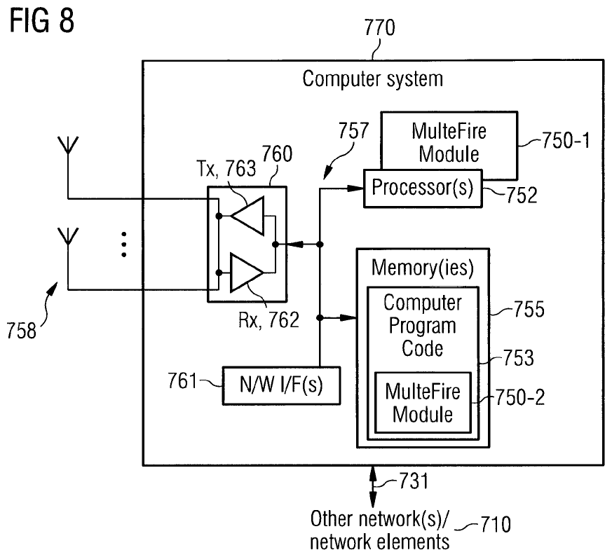

Referring to FIG. 8, this figure is a block diagram of an exemplary computer system 770 suitable for use as any of the network elements described herein. The computer system 770 may include one or more processors 752, one or more memories 755, one or more network interfaces (N/W I/F(s)) 761, and one or more transceivers 760 interconnected through one or more buses 757. Not all these would be used for each possible network element, as described more below. Each of the one or more transceivers 760 includes a receiver, Rx, 762 and a transmitter, Tx, 763. The one or more transceivers 760 are connected to one or more antennas 758. The one or more memories 755 include computer program code 753. The computer system includes a MulteFire module 750, comprising one of or both parts 750-1 and/or 750-2, which may be implemented in a number of ways. The MulteFire module 750 may be implemented in hardware as MulteFire module 750-1, such as being implemented as part of the one or more processors 752. The MulteFire module 750-1 may be implemented also as an integrated circuit or through other hardware such as a programmable gate array. In another example, the MulteFire module 750 may be implemented as MulteFire module 750-2, which is implemented as computer program code 753 and is executed by the one or more processors 752. For instance, the one or more memories 755 and the computer program code 753 are configured to, with the one or more processors 752, cause the computer system 770 to perform one or more of the operations as described herein. The one or more network interfaces 761 communicate over a network 710 (which can include a wired or wireless network to other network element(s)) such as via the link 731 (and e.g., via one or more interfaces over the link 731). The one or more buses 757 may be address, data, or control buses, and may include any interconnection mechanism, such as a series of lines on a motherboard or integrated circuit, fiber optics or other optical communication equipment, wireless channels, and the like.

Although the term “MulteFire” is used for the module 750, this is not meant to be limiting. Module 750 may also be used for LTE radio technologies not operating in licensed spectrum. In particular, radio technologies may be used that do not have direct communication with an HSS server for subscriber data retrieval and authentication, where instead they access an AAA server.

Any wireless network devices such as a UE or an AP would contain the transceiver 760 and the antenna(s) 758, but any network devices that are not wireless would not. Also, the network interface(s) 761 are meant in a general sense, and include interfaces for cellular networks, Wi-Fi networks, and the like.

The advantages and technical effects of one or more of the embodiments described above include the followings:

Legacy SCEF, MTC-IWF, SCS and AS in a PLMN can be used with minor modifications. It is possible the only modification is the modification of T7 interface needed, as NHN is not a PLMN.

No new procedures in the 3GPP networks are foreseen, only some additional information elements are needed on AAA interfaces.

This architecture also enables deployment and use of SCEF by Participating Service Providers (PSPs) that are not PLMNs. In that case, IMSI and MSISDN related identities may be replaced with other PSP-specific or UE-specific identities, and may be conveyed for example using NAI related formatting.

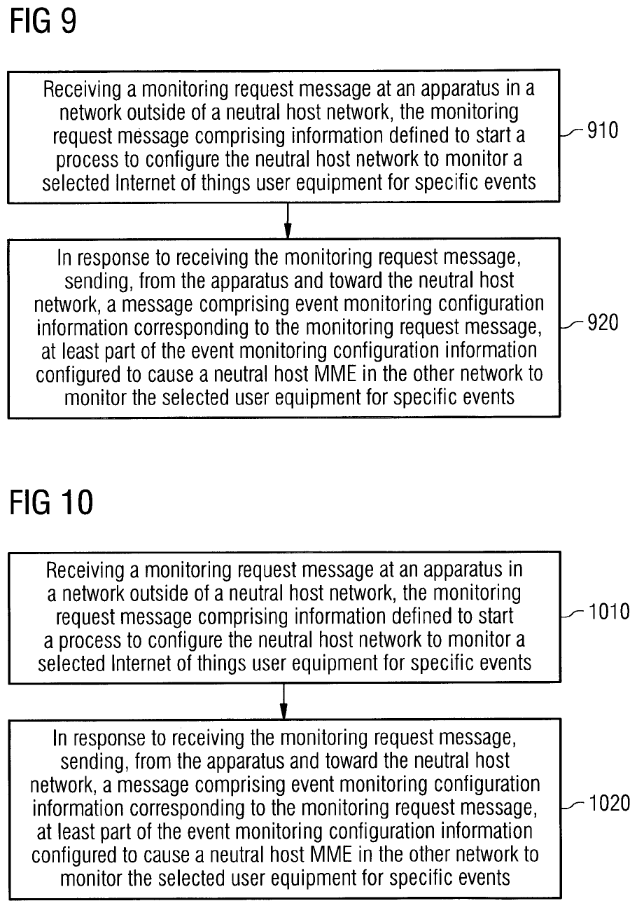

FIGS. 9 to 12 are logic flow diagrams for adding SCEF to MF in NHN access mode, and illustrate the operation of an exemplary method or methods, a result of execution of computer program instructions embodied on a computer readable memory, functions performed by logic implemented in hardware, and/or interconnected means for performing functions in accordance with exemplary embodiments. Each of these figures also corresponds to a network entity implementing certain functionality, and each of these network entities may be implemented as described above with respect to FIG. 8.

FIG. 9 corresponds to a network entity implementing the HSS of FIG. 5. In block 910, the network entity performs the operation of receiving a monitoring request message at an apparatus in a network outside of a neutral host network. The monitoring request message comprises information defined to start a process to configure the neutral host network to monitor a selected Internet of things user equipment for specific events. In block 920, the network entity performs the operation of in response to receiving the monitoring request message, sending, from the apparatus and toward the neutral host network, a message comprising event monitoring configuration information corresponding to the monitoring request message, at least part of the event monitoring configuration information configured to cause a neutral host MME in the other network to monitor the selected user equipment for specific events.

FIG. 10 corresponds to a network entity implementing the PSP AAA/Subscriber database of FIG. 6. In block 1010, a network entity performs the operation of receiving a monitoring request message at an apparatus in a network outside of a neutral host network, the monitoring request message comprising information defined to start a process to configure the neutral host network to monitor a selected Internet of things user equipment for specific events. In block 1020, the network entity performs the operation of in response to receiving the monitoring request message, sending, from the apparatus and toward the neutral host network, a message comprising event monitoring configuration information corresponding to the monitoring request message, at least part of the event monitoring configuration information configured to cause a neutral host MME in the other network to monitor the selected user equipment for specific events.

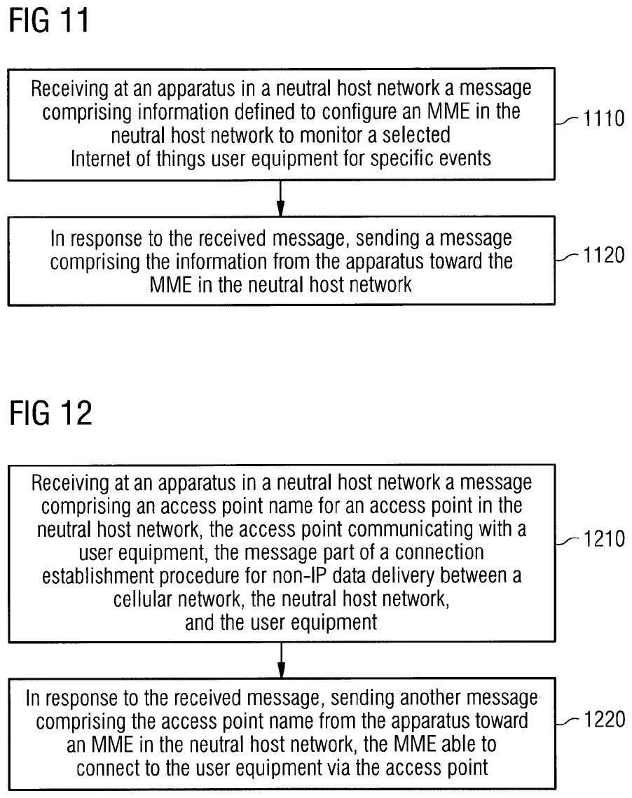

FIG. 11 corresponds to a network entity implementing the local AAA proxy of FIG. 5. A network entity in block 1110 performs the operation of receiving at an apparatus in a neutral host network a message comprising information defined to configure an MME in the neutral host network to monitor a selected Internet of things user equipment for specific events. In block 1120, the network entity performs the operation of in response to the received message, sending a message comprising the information from the apparatus toward the MME in the neutral host network.

FIG. 12 corresponds to a network entity implementing the local AAA proxy of FIG. 7. A network entity in block 1210 performs the operation of receiving at an apparatus in a neutral host network a message comprising an access point name for an access point in the neutral host network, the access point communicating with a user equipment, the message part of a connection establishment procedure for non-IP data delivery between a cellular network, the neutral host network, and the user equipment. In block 1220, the network entity performs the operation of in response to the received message, sending another message comprising the access point name from the apparatus toward an MME in the neutral host network, the MME able to connect to the user equipment via the access point

It should be noted that FIGS. 9-12 are described as using a single network entity, but it should be considered that these could use multiple network entities performing the same functionality.

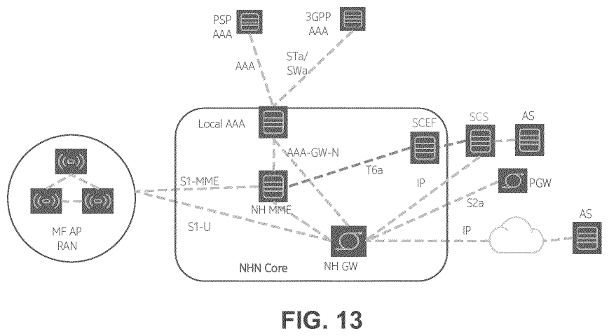

In an alternative solution/scenario (shown in FIG. 13) the SCEF may reside in the NHN core network with the following impacts on the NHN core network:

Implementing the SCEF

Implementing the T6a interface between the SCEF and NH MME

Establishing a trust domain incorporating the SCEF and the SCS/AS entities

Note the SCS and Application Servers could reside either inside the NHN core network, outside the NHN Core Network or both locations.

SCEF related functions identified for MF NHN have these dependencies on the HSS in the PSP MNO network:

Device triggering requires the MTC-IWF query the HSS for the serving CN node to correctly deliver the trigger information. The HSS is also used to map the device identity used by the applications to the device's IMSI.

Event monitoring configuration requires the SCEF to inform the HSS so the HSS can deliver updated event monitoring configuration information to the 3GPP MME via S6a.

NIDD requires APN and SCEF routing information to establish a connection. In 3GPP networks, this information is sent by the HSS to the MME over S6a during attach.

When the SCEF is in NHN, the NHN must configure APN which the UE uses to establish a NIDD connection with the SCEF.

The lack of an interface to the HSS is the key limitation of this scenario. Resolving these dependencies for this option requires adding the required HSS functionality to the MF NHN. Since the MF NHN architecture does not support a HSS or any interface to a HSS, adding this functionality would be a major impact to the architecture.

As mentioned previously, the key problem with this alternative solution/scenario is the lack of HSS support in the MF NHN. The SCEF functions identified for MF NHN have a heavy dependency on the HSS for identity management and subscription management. These capabilities have to be replicated in the NHN core network. This scenario also introduces scaling concerns. With the SCEF in the NHN, MTC applications may have to establish sessions with multiple NHN SCEFs complicating their operation. Finally, not all IoT devices will only want access to applications associated with the NHN SCEF. These devices may need access to applications in the PSP domain (e.g. a 3GPP PSP) which necessitates and additional mechanism to reach those applications.

Furthermore, additional examples are provided below for the IWK-SCEF function being added to the NHN architecture.

### EXAMPLE 1

A method, comprising: receiving a monitoring request message at an apparatus in a network outside of a neutral host network, the monitoring request message comprising information defined to start a process to configure the neutral host network to monitor a selected Internet of things user equipment for specific events; and in response to receiving the monitoring request message, sending, from the apparatus and toward the neutral host network, a message comprising event monitoring configuration information corresponding to the monitoring request message, at least part of the event monitoring configuration information configured to cause a neutral host MME in the other network to monitor the selected user equipment for specific events.

### EXAMPLE 2

The method of example 1, wherein the apparatus comprises an HSS and the network outside of the neutral host network is a cellular network, and wherein the sent message is sent toward an AAA server in the cellular network and further toward an AAA proxy in the neutral host network.

### EXAMPLE 3

The method of any of examples 1 to 2, wherein the message comprising the event monitoring configuration information is contained in a push-profile-request message from the HSS to the AAA server in the cellular network

### EXAMPLE 4

The method of example 3, wherein the message comprising the event monitoring configuration information is also contained in an AA-Response message from an AAA server in the cellular network to an AAA proxy in the neutral host network.

### EXAMPLE 5

The method of any one of examples 1 to 4, wherein the event monitoring configuration information comprises a user identity and a user profile corresponding to a selected user equipment, and the user identity is a part of the event monitoring configuration information.

### EXAMPLE 6

The method of example 5, wherein the user identity comprises one of an IMSI, NAI, or MSISDN.

### EXAMPLE 7

The method of any one of examples 1 to 6, further comprising:

receiving at the apparatus a message indicating a result of the monitoring event configuration transfer; and

sending, from the apparatus and toward an SCEF, a message comprising a monitoring configuration response.

### EXAMPLE 8

The method of any of examples 1 to 7, wherein the neutral host network supports one or more unlicensed bands or non-licensed bands but does not have direct communication with an HSS server for subscriber data retrieval and authentication and instead has to access an AAA server in a cellular network.

### EXAMPLE 9

The method of any of examples 1 to 8, wherein the event monitoring configuration information can be configured for one or more of the following: user equipment reachability; changes in the user equipment location; loss of connectivity with the user equipment; and communication failure with the user equipment.

### EXAMPLE 10

A method, comprising:

receiving a monitoring request message at an apparatus in a network outside of a neutral host network, the monitoring request message comprising information defined to start a process to configure the neutral host network to monitor a selected Internet of things user equipment for specific events; and

in response to receiving the monitoring request message, sending, from the apparatus and toward the neutral host network, a message comprising event monitoring configuration information corresponding to the monitoring request message, at least part of the event monitoring configuration information configured to cause a neutral host MME in the other network to monitor the selected user equipment for specific events.

### EXAMPLE 11

The method of example 10, wherein the apparatus comprises one or more network entities having PSP AAA and subscriber database functionality and the network is a non-3GPP network, and wherein the sent message is sent toward an AAA proxy in the neutral host network.

### EXAMPLE 12

The method of any of examples 10 to 11, wherein the message comprising the event monitoring configuration information is contained in an AA-Response message or a Radius CoA message from a PSP AAA server in the non-3GPP network to an AAA proxy in the neutral host network.

### EXAMPLE 13

The method of any one of examples 1 or 3, wherein the event monitoring configuration information comprises a user identity and a user profile corresponding to a selected user equipment, and the user identity is a part of the event monitoring configuration information.

### EXAMPLE 14

The method of example 13, wherein the user identity comprises one of a CUI or a session identifier.

### EXAMPLE 15

The method of any one of examples 1 to 14, further comprising:

determining at the apparatus a result of the monitoring event configuration transfer; and

sending, from the apparatus and toward an SCEF, a message comprising a monitoring configuration response.

### EXAMPLE 16

The method of any of examples 1 to 15, wherein the neutral host network supports one or more unlicensed bands or non-licensed bands but does not have direct communication with an HSS server for subscriber data retrieval and authentication and instead has to access an AAA server in a non-3GPP network.

### EXAMPLE 17

The method of any of examples 1 to 16, wherein the event monitoring configuration information can be configured for one or more of the following: user equipment reachability; changes in the user equipment location; loss of connectivity with the user equipment; and communication failure with the user equipment.

### EXAMPLE 18

A method, comprising:

receiving at an apparatus in a neutral host network a message comprising information defined to configure an MME in the neutral host network to monitor a selected Internet of things user equipment for specific events; and

in response to the received message, sending a message comprising the information from the apparatus toward the MME in the neutral host network.

### EXAMPLE 19

The method of example 18, wherein the apparatus comprises an AAA proxy.

### EXAMPLE 20

The method of any of examples 18 to 19, wherein the received and sent messages are formatted as AA-Resp messages.

### EXAMPLE 21

The method of any of examples 18 to 20, wherein the event monitoring configuration information can be configured for one or more of the following: user equipment reachability; changes in the user equipment location; loss of connectivity with the user equipment; and communication failure with the user equipment.

### EXAMPLE 22

The method of any of examples 18 to 21, wherein the neutral host network supports one or more unlicensed bands or non-licensed bands but does not have direct communication with an HSS server for subscriber data retrieval and authentication and instead has to access an AAA server in one of a cellular network or the non-3GPP network.

### EXAMPLE 23

A method, comprising:

receiving at an apparatus in a neutral host network a message comprising an access point name for an access point in the neutral host network, the access point communicating with a user equipment, the message part of a connection establishment procedure for non-IP data delivery between a cellular network, the neutral host network, and the user equipment; and

in response to the received message, sending another message comprising the access point name from the apparatus toward an MME in the neutral host network, the MME able to connect to the user equipment via the access point.

### EXAMPLE 24

The method of example 23, wherein the apparatus comprises an AAA proxy in the neutral host network and the message is received from an AAA server in the cellular network.

### EXAMPLE 25

The method of any of examples 23 to 24, wherein the received and sent messages are formatted as DEA messages.

### EXAMPLE 26

The method of any of examples 23 to 24, wherein the neutral host network supports one or more unlicensed bands or non-licensed bands but does not have direct communication with an HSS server for subscriber data retrieval and authentication and instead has to access an AAA server in one of a cellular network or the non-3GPP network.

### EXAMPLE 27

An apparatus, comprising:

a neutral host network, wherein the neutral host network supports one or more unlicensed bands or non-licensed bands but does not have direct communication with an HSS server for subscriber data retrieval and authentication and instead has to access an AAA server in one of a cellular network or the non-3GPP network; and

an interworking service capability exposure function, wherein the interworking service capability exposure function is in the neutral host network.

### EXAMPLE 28

A computer program comprising program code for executingthe method according to any of examples 1 to 26.

### EXAMPLE 29

The computer program according to example 28, wherein the computer program is a computer program product comprising a computer-readable medium bearing computer program code embodied therein for use with a computer.

### EXAMPLE 30

An apparatus, comprising:

means for receiving a monitoring request message at an apparatus in a network outside of a neutral host network, the monitoring request message comprising information defined to start a process to configure the neutral host network to monitor a selected Internet of things user equipment for specific events; and

means, responsive to receiving the monitoring request message, for sending, from the apparatus and toward the neutral host network, a message comprising event monitoring configuration information corresponding to the monitoring request message, at least part of the event monitoring configuration information configured to cause a neutral host MME in the other network to monitor the selected user equipment for specific events.

### EXAMPLE 31

The apparatus of example 30, further comprising means for performing the methods of any of examples 2 to 9.

### EXAMPLE 32

An apparatus, comprising:

means for receiving a monitoring request message at an apparatus in a network outside of a neutral host network, the monitoring request message comprising information defined to start a process to configure the neutral host network to monitor a selected Internet of things user equipment for specific events; and

means, responsive to receiving the monitoring request message, for sending, from the apparatus and toward the neutral host network, a message comprising event monitoring configuration information corresponding to the monitoring request message, at least part of the event monitoring configuration information configured to cause a neutral host MME in the other network to monitor the selected user equipment for specific events.

33. The apparatus of example 32, further comprising means for performing the methods of any of examples 11 to 17.

### EXAMPLE 34

An apparatus, comprising:

means for receiving at an apparatus in a neutral host network a message comprising information defined to configure an MME in the neutral host network to monitor a selected Internet of things user equipment for specific events; and

means, responsive to the received message, for sending a message comprising the information from the apparatus toward the MME in the neutral host network.

### EXAMPLE 35

The apparatus of example 34, further comprising means for performing the methods of any of examples 19 to 22.

### EXAMPLE 36

An apparatus, comprising:

means for receiving at an apparatus in a neutral host network a message comprising an access point name for an access point in the neutral host network, the access point communicating with a user equipment, the message part of a connection establishment procedure for non-IP data delivery between a cellular network, the neutral host network, and the user equipment; and

means, responsive to the received message, for sending another message comprising the access point name from the apparatus toward an MME in the neutral host network, the MME able to connect to the user equipment via the access point.

### EXAMPLE 37

The apparatus of example 36, further comprising means for performing the methods of any of examples 24 to 26.

### EXAMPLE 38

A system comprising one or more of the apparatus of examples 27; 28 or 29; 30 or 31; 32 or 33.

### EXAMPLE 39

An apparatus, comprising:

one or more processors; and

one or more memories including computer program code,

the one or more memories and the computer program code configured, with the one or more processors, to cause the apparatus to perform a method according to any of examples 1 to 26.

### EXAMPLE 40

A computer program product comprising a computer-readable storage medium bearing computer program code embodied therein for use with a computer, the computer program code comprising code for causing the computer to perform a method according to any of examples 1 to b 26.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 8. A computer-readable medium may comprise a computer-readable storage medium (e.g., memories 755 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects are set out above, other aspects comprise other combinations of features from the described embodiments, and not solely the combinations described above.

It is also noted herein that while the above describes example embodiments of the invention, these descriptions should not be viewed in a limiting sense. Rather, there are several variations and modifications which may be made without departing from the scope of the present invention.

The following abbreviations that may be found in the specification and/or the drawing figures are defined as follows:

3GPP third generation partnership project

AAA authentication, authorization and accounting

AKA authentication and key agreement

AP access point

APN access point name

AS access stratum

AVP attribute-value pair

CIoT cellular internet of things

CIR configuration information request

CMA connection management answer

CMR connection management request

CoA change of authorization

CUI chargeable-user-identity

DB database

DEA Diameter EAP Answer

EAP extensible authentication protocol

GHz gigahertz

HPLMN home PLMN

HSS home subscriber server

ID identification

OF interface

IMSI international mobile subscriber identity

IoT Internet of things

IP Internet protocol

IWF interworking function

IWK interworking

IWK-SCEF Interworking SCEF

LAA licensed assisted access

LTE long term evolution

LTE-U LTE unlicensed

MF MulteFire

MFA MulteFire Alliance

MME mobility management entity

MNO mobile network operator

MSISDN mobile station international subscriber directory number

MTC machine-type communications

MTC-IWF MTC interworking function

NAI network access identifier

NCE network control element

NH neutral host

NHN neutral host network

NIDD non-IP data delivery

N/W network

PLMN public land mobile network

PPA push-profile-answer

PPR push-profile-request

PSP participating service provider

RAA re-authorization answer

RADIUS remote authentication dial in user service

RAN radio access network

RAR re-authorization request

Rel release

RRH remote radio head

Rx receiver

SCEF service capability exposure function

SCS services capability server

SGW serving gateway

TS technical standard

Tx transmitter

UE user equipment (e.g., a wireless, typically mobile device)

VPLMN visited PLMN

WFA Wi-Fi Alliance, an industry trade group

Wi-Fi A trademark of the Wi-Fi Alliance indicating a WLAN device certified by WFA

WLAN A technology for wireless local area networking with devices

1.-40. (canceled)

41. A method, comprising:
receiving a monitoring request message at an apparatus in a network outside of a neutral host network, the monitoring request message comprising information defined to start a process to configure the neutral host network to monitor a selected Internet of things user equipment for specific events; and
in response to receiving the monitoring request message, sending, from the apparatus and toward the neutral host network, a message comprising event monitoring configuration information corresponding to the monitoring request message, at least part of the event monitoring configuration information configured to cause a neutral host MME in the other network to monitor the selected user equipment for specific events.

42. The method of claim 41, wherein the apparatus comprises an HSS and the network outside of the neutral host network is a cellular network, and wherein the sent message is sent toward an AAA server in the cellular network and further toward an AAA proxy in the neutral host network.

43. The method of claim 41, wherein the message comprising the event monitoring configuration information is contained in a push-profile-request message from the HSS to the AAA server in the cellular network.

44. The method of claim 43, wherein the message comprising the event monitoring configuration information is also contained in an AA-Response message from an AAA server in the cellular network to an AAA proxy in the neutral host network.

45. The method of claim 41, wherein the apparatus comprises one or more network entities having PSP AAA and subscriber database functionality and the network is a non-3GPP network, and wherein the sent message is sent toward an AAA proxy in the neutral host network.

46. The method of claim 41, wherein the message comprising the event monitoring configuration information is contained in an AA-Response message or a Radius CoA message from a PSP AAA server in the non-3GPP network to an AAA proxy in the neutral host network.

47. The method of claim 41, wherein the event monitoring configuration information comprises a user identity and a user profile corresponding to a selected user equipment, and the user identity is a part of the event monitoring configuration information.

48. The method of claim 47, wherein the user identity comprises one of a CUI or a session identifier.

49. A method, comprising:
Receiving, at an apparatus in a neutral host network, a message comprising information defined to configure an MME in the neutral host network to monitor a selected Internet of things user equipment for specific events; and
in response to the received message, sending a message comprising the information from the apparatus toward the MME in the neutral host network.

50. The method of claim 49, wherein the apparatus comprises an AAA proxy.

51. The method of claim 49, wherein the received and sent messages are formatted as AA-Resp messages.

52. The method of claim 49, wherein the event monitoring configuration information can be configured for one or more of the following: user equipment reachability; changes in the user equipment location; loss of connectivity with the user equipment; and communication failure with the user equipment.

53. The method of claim 49, wherein the neutral host network supports one or more unlicensed bands or non-licensed bands but does not have direct communication with an HSS server for subscriber data retrieval and authentication and instead has to access an AAA server in one of a cellular network or the non-3GPP network.

54. A method, comprising:
receiving, at an apparatus in a neutral host network, a message comprising an access point name for an access point in the neutral host network, the access point communicating with a user equipment, the message part of a connection establishment procedure for non-IP data delivery between a cellular network, the neutral host network, and the user equipment; and
in response to the received message, sending another message comprising the access point name from the apparatus toward an MME in the neutral host network, the MME able to connect to the user equipment via the access point.

55. The method of claim 54, wherein the apparatus comprises an AAA proxy in the neutral host network and the message is received from an AAA server in the cellular network.

56. The method of claim 54, wherein the received and sent messages are formatted as DEA messages.

57. The method of claim 54, wherein the neutral host network supports one or more unlicensed bands or non-licensed bands but does not have direct communication with an HSS server for subscriber data retrieval and authentication and instead has to access an AAA server in one of a cellular network or the non-3GPP network.

58. An apparatus, comprising:
at least one processor; and
at least one memory including computer program code;
the at least one memory and the computer program code configured to, with the at least one processor, cause the apparatus at least to:
receive a monitoring request message at an apparatus in a network outside of a neutral host network, the monitoring request message comprising information defined to start a process to configure the neutral host network to monitor a selected Internet of things user equipment for specific events; and
send, responsive to receiving the monitoring request message, from the apparatus and toward the neutral host network, a message comprising event monitoring configuration information corresponding to the monitoring request message, at least part of the event monitoring configuration information configured to cause a neutral host MME in the other network to monitor the selected user equipment for specific events.

59. An apparatus, comprising:
at least one processor; and
at least one memory including computer program code;
the at least one memory and the computer program code configured to, with the at least one processor, cause the apparatus at least to:
receive, at an apparatus in a neutral host network, a message comprising information defined to configure an MME in the neutral host network to monitor a selected Internet of things user equipment for specific events; and
send, responsive to the received message, a message comprising the information from the apparatus toward the MME in the neutral host network.

60. An apparatus, comprising:
at least one processor; and
at least one memory including computer program code;
the at least one memory and the computer program code configured to, with the at least one processor, cause the apparatus at least to:
receive, at an apparatus in a neutral host network, a message comprising an access point name for an access point in the neutral host network, the access point communicating with a user equipment, the message part of a connection establishment procedure for non-IP data delivery between a cellular network, the neutral host network, and the user equipment; and
send, responsive to the received message, another message comprising the access point name from the apparatus toward an MME in the neutral host network, the MME able to connect to the user equipment via the access point.
